(19) United States
(12) Patent Application Publication
(10) Pub. No.: US 2014/0022803 A1
(43) Pub. Date: Jan. 23, 2014

(54) SPOTLIGHT DEVICE

(71) Applicants: Ivan Liu, Taichung City (TW); Shu-Ping Liu, Taipei (TW)

(72) Inventors: Ivan Liu, Taichung City (TW); Shu-Ping Liu, Taipei (TW)

(73) Assignee: DIODE-ON OPTOELECTRONICS LIMITED, Taichung City (TW)

(21) Appl. No.: 13/555,305

(22) Filed: Jul. 23, 2012

(51) Int. Cl. F21V 21/26

(52) U.S. Cl. 362/427

(57) ABSTRACT

A spotlight device includes a support member, a pivot joint mechanism, and a lighting member. The pivot joint mechanism includes a first pivot connection part provided on the support member, and a second pivot connection part connected rotatably to the first pivot connection part. The lighting member includes a base plate on which the second pivot connection part is mounted, a light emitting component mounted on the base plate, and a light directing cap extending from a periphery of the base plate and cooperating with the base plate to define a receiving space. The light emitting component is disposed in the receiving space.

### BACKGROUND OF THE INVENTION

1. Field of the Invention

The invention relates to a spotlight device, and more particularly to a spotlight device suitable for illuminating articles being exhibited or displayed.

2. Description of the Related Art

Conventional spotlights for use in a display case to illuminate articles being exhibited or displayed are usually recessed lights fixed in the display case. When the articles are small, the distance from the recessed lights may be too far to focus light thereon, resulting in an adverse effect on presentation.

The aforesaid spotlight is thus not suitable for use with small exhibited or displayed articles, thereby resulting in lower flexibility in application.

### SUMMARY OF THE INVENTION

Therefore, an object of the present invention is to provide a spotlight device suitable for illuminating small exhibited or displayed articles.

According to the present invention, a spotlight device comprises:

a support member;

a pivot joint mechanism including a first pivot connection part provided on the support member, and a second pivot connection part connected rotatably to the first pivot connection part; and
a lighting member including:
   a base plate having a first surface on which the second pivot connection part is mounted, and a second surface opposite to the first surface;
   a light emitting component mounted on the second surface of the base plate; and
   a light directing cap extending from a periphery of the base plate and cooperating with the base plate to define a receiving space, the light emitting component being disposed in the receiving space.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a first preferred embodiment of the spotlight device according to the present invention;

FIG. 2 is a partly sectional view of the first preferred embodiment;

FIG. 3 is a schematic diagram showing the first preferred embodiment in a state of use; and

FIG. 4 is a sectional view of a second preferred embodiment of the spotlight device according to the present invention.

### DETAILED DESCRIPTION OF THE PREFERRED EMBODIMENTS

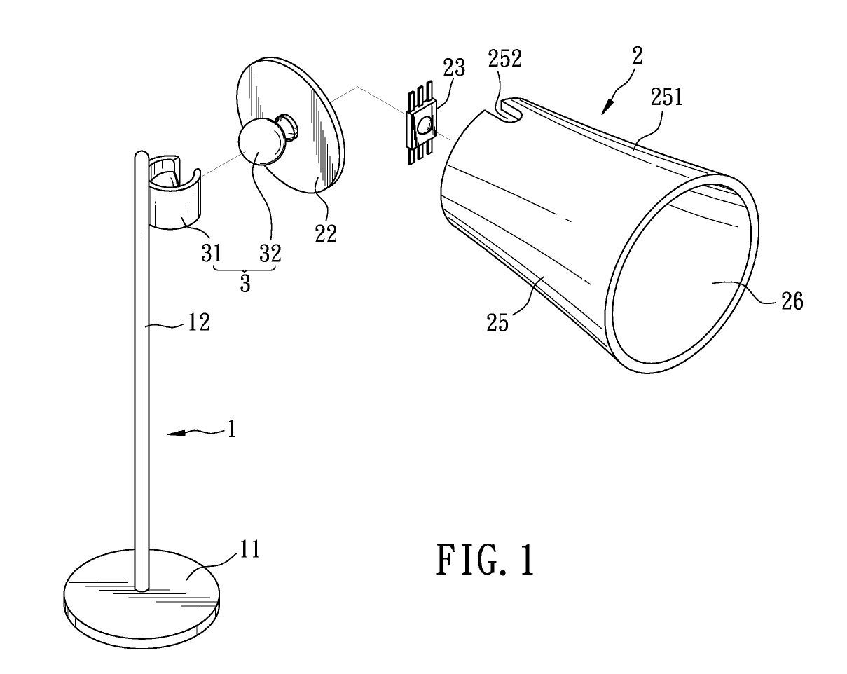

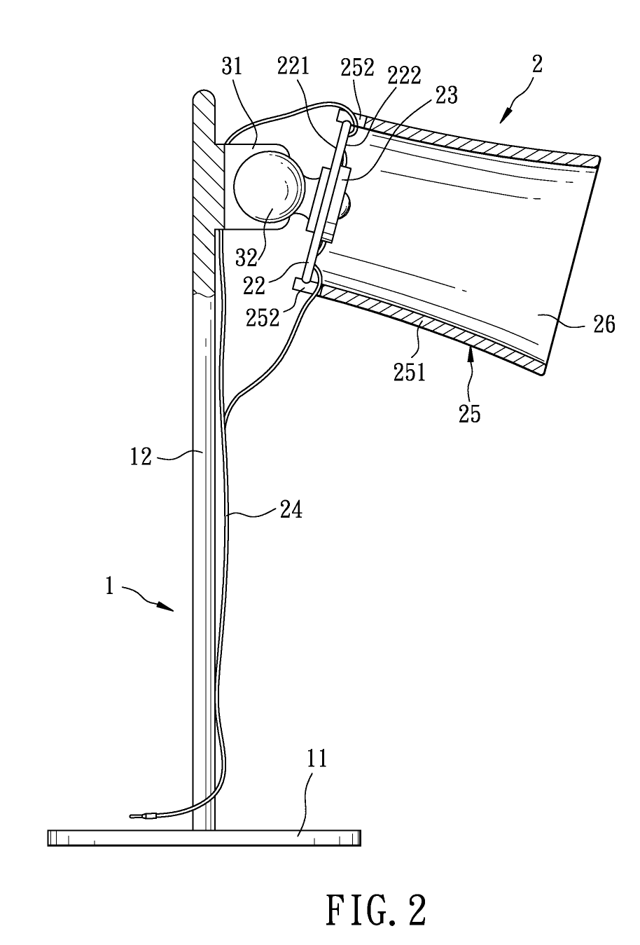

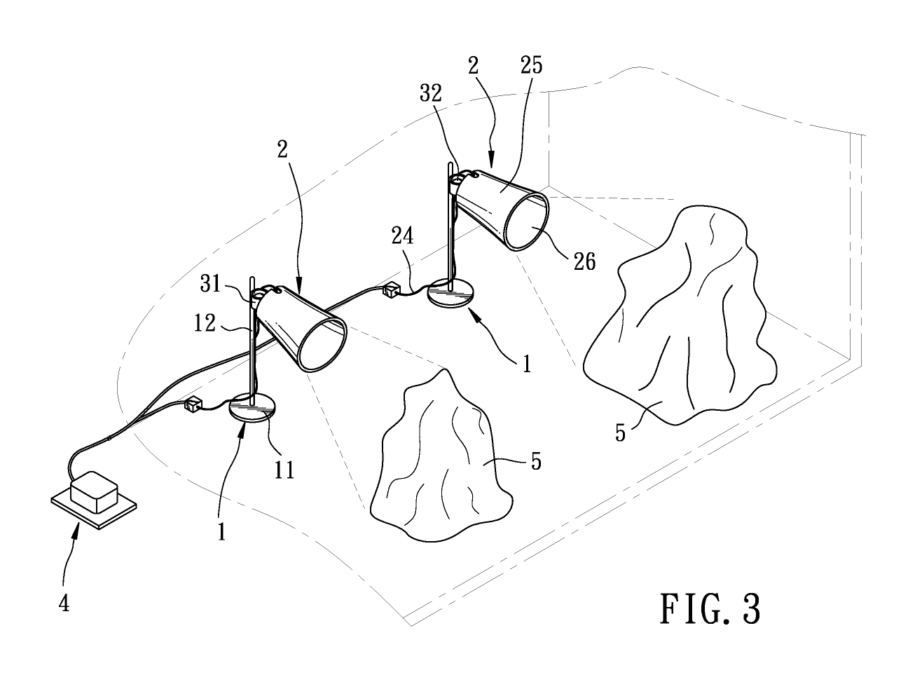

Referring to FIG. 1 to FIG. 3, the first preferred embodiment of the spotlight device according to this invention is shown to include a support member 1, a lighting member 2, and a pivot joint mechanism 3.

In this embodiment, the support member 1 includes a base 11 and a support shaft 12 upwardly extending from the base 11.

The pivot joint mechanism 3 includes a first pivot connection part 31 connected to the support shaft 12, and a second pivot connection part 32 connected rotatably to the first pivot connection part 31 . In this embodiment, the pivot joint mechanism 3 is a ball-and-socket joint mechanism, wherein the first pivot connection part 31 is a socket part and the second pivot connection part 32 is a ball part.

The lighting member 2 includes a base plate 22, a light emitting component 23, electrical wiring 24 electrically connected to the light emitting component 23, and a light directing cap 25. The base plate 22 has a first surface 221 on which the second pivot connection part 32 is mounted, and a second surface 222 opposite to the first surface 221. The light emitting component 23 is mounted on the second surface 222 of the base plate 22. In this embodiment, the light emitting component 23 is but not limited to a light emitting diode (LED) component.

The light directing cap 25 extends from a periphery of the base plate 22 and cooperates with the base plate 22 to define a receiving space 26. The light emitting component 23 is disposed in the receiving space 26. In this embodiment, the light directing cap 25 has a frustoconical wall 251 connected to and diverging from the base plate 22. The frustoconical wall 251 is formed with at least a wire groove 252 passing therethrough and disposed adjacent to the base plate 22 for passage of the electrical wiring 24 into the receiving space 26. In this embodiment, the frustoconical wall 251 is formed with two wire grooves 252.

To assemble the spotlight device, the light directing cap 25 is engaged to the periphery of the base plate 22, and the electrical wiring 24 is passed through the wire grooves 252. Thereafter, the second connection part 32 is connected to the first connection part 31 on the support member 1 to complete the assembly operation.

In use, the spotlight device can be placed at an appropriate location with the electrical wiring 24 electrically connected to an electrical power source 4. By rotating the lighting member 2 via the pivot joint mechanism 3, the projection angle of the light from the spotlight device can be adjusted as required. Since the light emitting component 23 of the present invention is the LED component which is available in various colors, users may choose an appropriate color according to the exhibited or displayed articles 5 to achieve a desired visual presentation effect.

It should be noted that the height of the spotlight device of this embodiment may be adjusted by selection of the support member 1 with the desired height. When the exhibited or displayed article 5 is tall, a taller support member 1 may be chosen. Otherwise, a shorter support member 1 may be used.

Moreover, since the present invention is light, small, and power-saving, multiple spotlight devices maybe used at the same time for illumination of a single article 5 or multiple articles 5.

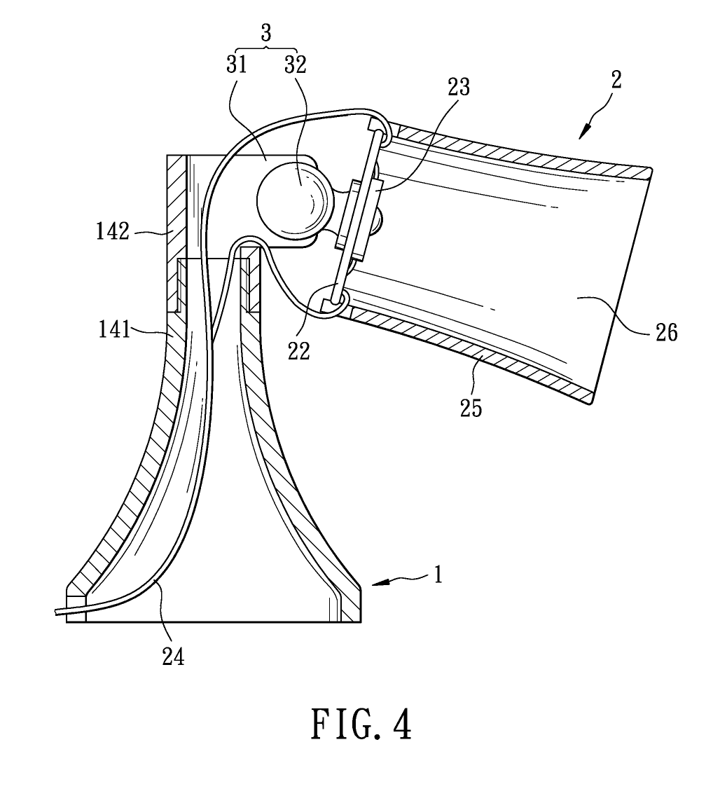

Referring to FIG. 4, the second preferred embodiment of the spotlight device according to this invention is shown to be similar to the first preferred embodiment, and includes a support member 1, a lighting member 2, and a pivot joint mechanism 3.

This embodiment differs from the first embodiment in that the support member 1 is tubular and has a lower tube part 141 and an upper tube part 142 having two ends respectively connected to the lower tube part 141 and the first pivot connection part 31. The upper tube part 142 is movable upward and downward relative to the lower tube part 141. In this embodiment, the upper tube part 142 is coupled removably and threadedly to the lower tube part 141.

In addition to the effects that the first preferred embodiment can achieve, the height of the second preferred embodiment can be fine tuned by moving the upper tube part 142 upward and downward relative to the lower tube part 141, thereby enhancing flexibility in application. Moreover, the electrical wiring 24 can be hidden in the lower and upper tube parts 141, 142, to thereby enhance the aesthetic appeal.

To sum up, some advantages of the present invention are as follows:.

1. The light emitting component 23 is an LED component, which is more power-saving compared to the conventional spotlight, and which is available in different colors, so that the visual presentation effect can be enhanced.

2. Due to its being light in weight and small in volume, the present invention is easily moved and placed as desired. When the article 5 is too small to cooperate with a recessed light fixed in a display case, the present invention can be placed nearby the article 5, so that the light from the light emitting component 23 can be focused on the article 5, resulting in not only enhancement of the visual presentation effect but also flexible adjustment in response to different placements or different exhibited or displayed articles.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A spotlight device comprising:
a support member;
a pivot joint mechanism including a first pivot connection part provided on said support member, and a second pivot connection part connected rotatably to said first pivot connection part; and
a lighting member including:
a base plate having a first surface on which said second pivot connection part is mounted, and a second surface opposite to said first surface;
a light emitting component mounted on said second surface of said base plate; and
a light directing cap extending from a periphery of said base plate and cooperating with said base plate to define a receiving space, said light emitting component being disposed in said receiving space.

2. The spotlight device as claimed in claim 1, wherein said light emitting component is a light emitting diode (LED) component.

3. The spotlight device as claimed in claim 1, wherein said light directing cap has a frustoconical wall connected to and diverging from said base plate, said frustoconical wall being formed with a wire groove passing therethrough and disposed adjacent to said base plate for passage of electrical wiring into said receiving space.

4. The spotlight device as claimed in claim 1, wherein said support member includes a base and a support shaft upwardly extending from said base, said first pivot connection part being connected to said support shaft.

5. The spotlight device as claimed in claim 1, wherein said support member is tubular and has a lower tube part and an upper tube part having two ends respectively connected to said lower tube part and said first pivot connection part, said upper tube part being movable upward and downward relative to said lower tube part.

6. The spotlight device as claimed in claim 5, wherein said upper tube part is coupled removably and threadedly to said lower tube part.

7. The spotlight device as claimed in claim 1, wherein said pivot joint mechanism is a ball-and-socket joint mechanism, one of said first and second pivot connection parts being a socket part, the other one of said first and second pivot connection parts being a ball part.

8. The spotlight device as claimed in claim 7, wherein said first pivot connection part is a socket part and said second pivot connection part is a ball part.
